(19) United States
(12) Patent Application Publication
(10) Pub. No.: US 2006/0017946 A1
(43) Pub. Date: Jan. 26, 2006

(54) Font and text management in documents

(76) Inventors: Jose Abad Peiro, Barcelona (ES); Albert Serra, Barcelona (ES)

Correspondence Address: HEWLETT-PACKARD DEVELOPMENT COMPANY;Intellectual Property Administration, P.O. Box 272400, Fort Collins, CO, 80527-2400, US

(21) Appl. No.: 10/898,869

(22) Filed: Jul. 26, 2004

(51) Int. Cl. G06K 15/02; G06F 15/00

(52) U.S. Cl. 358/1.11; 358/1.18

(57) ABSTRACT

Font and text management within a document provides utility in authoring and/or printing documents. In one example, a first portion of the document is configured to include text and references to fonts for use in rendering the text. Additionally, a second portion of the document is configured to include a graphical representation of the text.

### BACKGROUND

There are a number of tasks which may take place between receipt of a document and the eventual generation of printout of the received document. In general, these tasks may be categorized into either of two classes. A first class of tasks is related to fixing problems in the document that could prevent production of satisfactory print output. Such tasks may be related to making changes to the document required to result in successful printing of the document. They may involve addition, deletion or alteration of content within the document, and may be made by or for the document creator. A second class of tasks is related to the physical production of the document itself, e.g., printing, finishing and post-production operations.

Both classes of tasks—particularly the first class, and to a lesser degree the second class—result from—or are exacerbated by—copyright laws which generally restrict the ability of authors to include copyright-protected fonts within documents. Such restrictions are in opposition to the objective of printing documents in the exact manner in which they were intended.

Partial solutions to these problems are known. For example, transformation of all font information into graphical images is a method by which a document may be produced without violating copyright laws. However, such a transformation does not allow the image to be edited after the graphical images are generated. A second partial solution is to transcode fonts into similar font sets which are not protected by copyright laws. At least in theory, this solution allows changes to be made to a completed document; however, a variety of problems make this solution unsatisfactory. First, this solution may in fact violate copyright laws, since the transform of the fonts may be a protected derivative of the protected fonts. Moreover, since most tools are not fully compatible with the transcoding, the transcoded fonts are not easily edited; accordingly, the edited fonts do not match the original fonts. Therefore, known attempts to solve these and other problems result in obvious flaws within the printed document, as well as an enormous amount of time invested by the document printer doing trial-and-error operations.

As a result, new and improved solutions to these and other problems would be welcome.

### SUMMARY

Font and text management within a document provides utility in authoring and/or printing documents. In one example, a first portion of the document is configured to include text and references to fonts for use in rendering the text. Additionally, a second portion of the document is configured to include a graphical representation of the text.

### BRIEF DESCRIPTION OF THE DRAWINGS

The following detailed description refers to the accompanying figures. In the figures, the left-most digit(s) of a reference number identifies the figure (Fig.) in which the reference number first appears. Moreover, the same reference numbers are used throughout the drawings to reference like features and components.

FIG. 1 is block diagram illustrating an example of a system for font and text management in documents.

FIG. 2 is a flow diagram illustrating an example of a method by which documents may be authored using the system for font and text management.

FIG. 3 is a flow diagram illustrating an example of a method by which documents may be printed using the system for font and text management.

FIG. 4 is a flow diagram illustrating an example of a method by which documents may be edited or otherwise altered using the system for font and text management.

### DETAILED DESCRIPTION

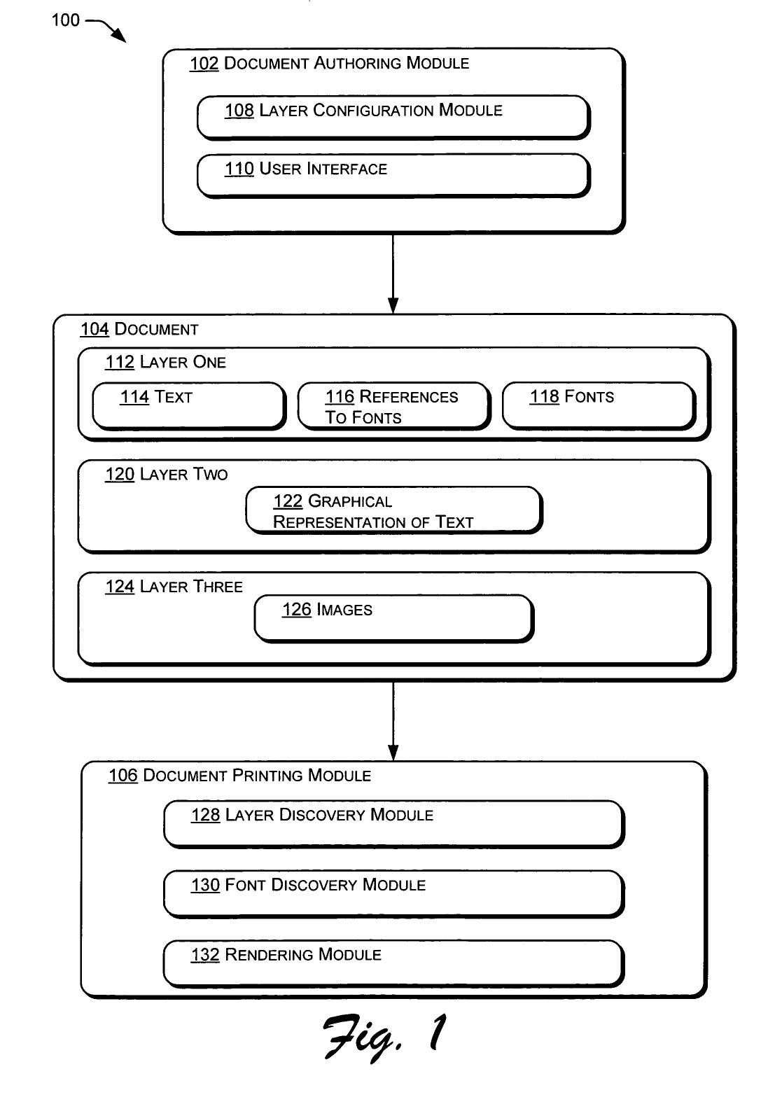

FIG. 1 shows an example of a system 100 for font and text management in documents. A document authoring module 102 is configured to allow a user to author a document 104. Once the document 104 is authored, it may be passed to a document printing module 106 for printing.

The document authoring module 102 may be configured for authoring documents 104 of various types, including: PDF (portable document format) documents, PCL® (printer control language) documents, PostScript® document and others. The document authoring module 102 and document printing module 106 may be configured as one or more plug-ins for an application, such as Adobe® Acrobat®, or may be configured as one or more stand-along applications. The document 104 may additionally be configured to include one or more portions, layers, sections or other components. In the example of FIG. 1, a layer configuration module 108 is configured to create a PDF document having the two or more portions configured as layers (wherein three layers are illustrated as an example). The number of layers and their contents may be controlled by the author by providing input to a user interface 110 provided by the document authoring module 102. An exemplary user interface 110 allows the user to select the format of the document 104 (e.g. PDF, PostScript®, etc.), the number of layers (e.g. two, three or more), the status of each layer (e.g. hidden or visible) and other factors. The user interface 110 maybe graphically oriented, command-line oriented or otherwise configured.

A first layer 112 within the document 104 may be configured to include content in the form of text 114, which may be supplied by the author. One or more sections of the text 114 may be associated with one or more fonts. Accordingly, one or more references to fonts 116 may be included in the first layer 112 to indicate the associated font(s).

Advantageously, the first layer 112, containing text 114 and references to fonts 116, is suitable for being edited. In particular, the text 114 and fonts within that layer may be manipulated by many authoring programs, such as word processors, presentation applications (e.g. PowerPoint®) and many others.

Optionally, actual fonts 118 may be included within the layer 112, where copyright laws permit. The utility of this inclusion is not universal, however, since fonts which copyright laws allow to be included will probably already be present on any system which is used to render and print the document 104.

A second layer 120 may be configured by the layer configuration module 108 to include a graphical representation 122 of the text 114 found in the second layer 112. Advantageously, a graphical representation 122 of the text 114—created, for example, using vector elements—does not need fonts or references to fonts to be rendered and printed, since graphical images are rendered and printed independent of text and fonts. As a result, the second layer 120 may be printed without reference to any fonts. Therefore, failure of a printer or other output device to have a legal copy of any particular font is not fatal, since the graphical representation 122 is printed without utilizing any fonts or references to fonts.

Use of the second layer 120 therefore provides an alternative to use of the first layer 112. Generally, where the fonts associated with references 116 are present on a printing system, use of the first layer is preferable. Additionally, were the fonts are available and changes need to be made to the document, then the text 114 of the first layer is fully editable. Alternatively, where the fonts are not present, use of the second layer is preferable.

A third layer 124 may optionally be included within the document 104, and may include an image of the document or images in the document. The third layer may be organized according to pages within the document, or may be organized according to the entire document. In one example, the third layer may include images of the document, such as images of each page of the document, including a representation of the text and/or the images in the document. The third layer may also include images in the document, such as images required by other layers, such as layer one 112. For example, the third layer 124 may include one or more graphical images 126, such as business graphics, logos, photographs and/or any other type of graphical image. The third layer 124 is typically not directly related to the text 114 or images of the text 122; instead, the third layer 124 contains the photos, images and/or graphics included by the user, such as when operating the document authoring module 102.

The document printing module 106 is configured to render and print the document 104. An example of a document printing module 106 is seen in FIG. 1, and contains a layer discovery module 128, a font discovery module 130 and a rendering module 132. The layer discovery module 128 determines how many layers are present in the document 104. In particular, the layer discovery module 126 is configured to recognize hidden layers when present. For example, the first layer 112 may be hidden, thereby allowing the document 104 to be processed without benefit of that layer by any document printing modules that are not configured to find hidden layers. However, operation of the layer discovery module 128 enables recognition of hidden layers, thereby making them available for utilization.

The font discovery module 130 is configured to locate fonts indicated by the references 116, or fonts 118 which are located within the layer 112. For example, references to fonts 116 may be present within one or more layers. To render the text 114 in the manner intended by the document authoring module 102, it will be necessary to determine if the referenced fonts are available on the system which will be used to render and print the document. This determination may be made by the font discovery module 130, which inventories the available fonts for comparison against the required fonts.

A rendering module 132 is configured to render the document 104, thereby facilitating the printing process. The rendering module is configured to render the first layer 112 when that layer is discovered (if hidden) by the layer discovery module 128, and when the fonts to which there are references 116 are available and/or when fonts 118 are included within the layer 112. Alternatively, the rendering module 132 is configured to render the second layer 120, which contains a graphical representation 122 of the text. The rendering module 132 may additionally render a third layer 124, containing one or more images 126, if the third layer is present.

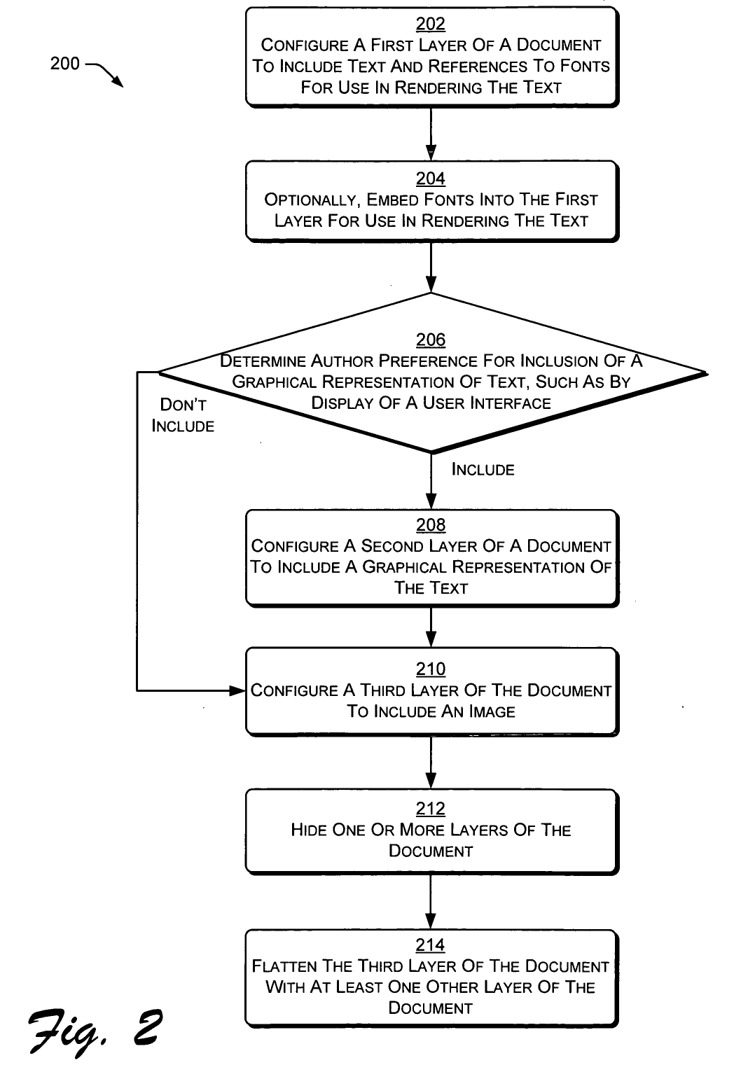

FIG. 2 shows an example of a method 200 by which documents may be created and/or authored using a system for font and text management, such as the system 100 seen in FIG. 1. Such documents may be authored using PDF, PCL®, PostScript® or other formats. While the discussion of FIG. 2 is directed primarily to the use of layers within a PDF document, non-layer portions and/or non-PDF documents could be substituted.

At block 202, a first portion of a document is configured to include text and references to fonts. For example, a first layer 112 of a document 104 may be configured to include text 114 and references to fonts 116 for use in rendering the text. In an optional configuration seen at block 204, actual fonts 118 can be embedded within the first layer 112, instead of—or in addition to—the references 116 to fonts. In some cases this may be beneficial. However, fonts which can be legally embedded within the document are typically found on most printing systems, e.g., using an asset management component with fonts, which might be used to print the document; accordingly, embedding fonts may provide little utility and use a larger amount of space in disk.

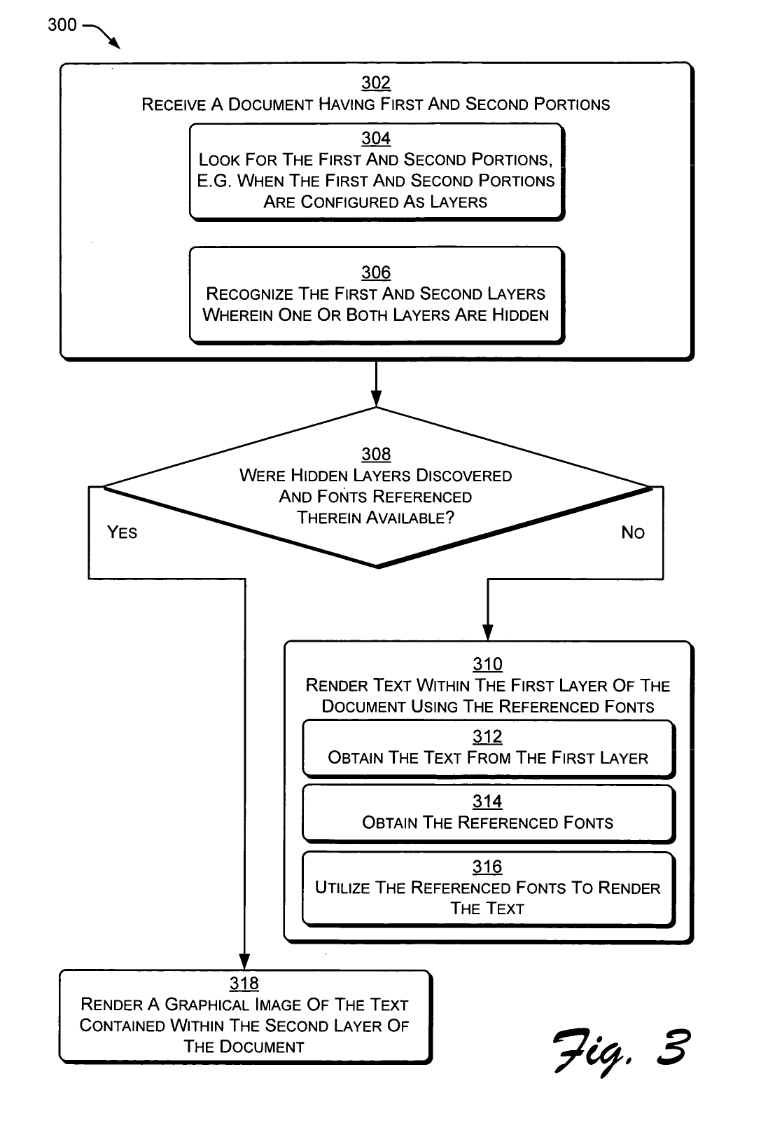

At block 206, it is determined if the author prefers to include a graphical representation 122 of text within the document 104. Such an inclusion may be preferred, for example, to preserve the integrity of the original document. The author preference may be indicated in any desired manner, such as by display of a user interface 110 (FIG. 1) into which the author may make an indication of preference. As seen at block 208, where the author indicates a preference for use of the graphical representation 122 of text, the layer configuration module 108 (FIG. 1) may be used to insert the graphical representation 122 as a second layer 120. (As will be seen in the discussion of FIG. 3, the second layer 120 containing the graphical representation 122, together with the first layer 112 having resources including text 114 and font references 116, constitute two alternative layers from which a document printing module 106 may select when rendering the document.)

At block 210, a third portion of the document may optionally be configured to include an image. For example, a third portion may be configured as a third layer 124, and may include an image 126 such as business graphics, a logo, a photograph, artwork or any other graphical image.

At block 212, one or more layers of the document may be hidden. For example, the user interface 110 may be used by the author to instruct the layer configuration module 108 to hide the first layer 112. Hiding a layer allows document printing modules not configured to recognize a plurality of layers to process the document 104 in a known manner, using only non-hidden layers. In contrast, document printing modules (e.g. the documenting printing module 106 of FIG. 1) can be configured to automatically recognize and utilize the hidden layer(s). Alternatively, one or more layers may be hidden by the document authoring module 102 in an automated manner. An automation of the process by which a layer(s) is hidden frees the author of the need to instruct the document authoring module 102 on this matter.

At block 214, the third portion of the document may be flattened with at least one other portion of the document. For example, layer three 124 of the document 104 may be flattened with either layer one 112 or layer two 120. Thus, the flattening results in the text 114 of layer one 112 or the text representation 122 of layer two 120 being combined with the images (e.g. photographs) of layer three 124. Accordingly, the flattened document will include text and images. Once flattened, the document may be processed by conventional document printing systems.

FIG. 3 is a flow diagram illustrating an example of a method 300 by which documents (e.g. document 104 of FIG. 1) may be printed using a system, such as system 100 of FIG. 1, for font and text management.

At block 302, a document having first and second portions is received. Receipt of the document may be performed in a variety of ways, one of which is illustrated for purposes of example at blocks 304, 306. In the example of block 304, a document 104 (FIG. 1) is received by a document printing module 106 (FIG. 1). In this example, a layer discovery module 128 looks for layers, and finds the first and second portions configured as first and second layers 112, 120 (FIG. 1). The document may be a PDF, PCL®, PostScript® or document of an alternate format. A further example of the process by which a document is received is also seen at block 306, wherein the first and second layers 112, 120 are recognized, even if hidden. Where hidden layers are found, a document printing module 106 is able to utilize their content. For example, if a hidden first layer 112 is discovered, then the text 114 and font references 116 may be included within the content of the document 104.

At block 308, a check is made to determine if hidden layers were discovered and if the fonts referenced by the one or more hidden layers were available. For example, the check confirms if fonts associated with the references 116 are available on the system which is being utilized to print the document 104 in a hidden layer 112. Such as check can be made by the font discovery module 130 or similar structure. Note that if the layer discovery module 128 failed to discover hidden layer 112, then layer 120 can be utilized in its place.

Where hidden layers were discovered and the fonts referenced within the hidden layers were available, block 310 indicates that the text within the first layer 112 of the document is rendered using the referenced fonts. In one example, this may be performed as seen in blocks 312-316. At block 312, the text 114 from the first layer 112 is obtained. Because the hidden layer was previously recognized (such as by the layer discovery module 128), the text 114 is easily obtained. At block 314, the referenced fonts are obtained by using the references 116 found in the first layer 112 (such as by the font discovery module 130). At block 316, the referenced fonts are used in a process which renders the text 114 of the document 104 (such as by the rendering module 132).

Where hidden layers were discovered and the fonts referenced within the hidden layers were not available, block 318 indicates that a graphical representation of the text is rendered. Typically, the graphical representation of the text 122 is found in a second layer 120 of the document 104, which is typically visible, but may be hidden. The rendering may be performed by the rendering module 132 or similar software.

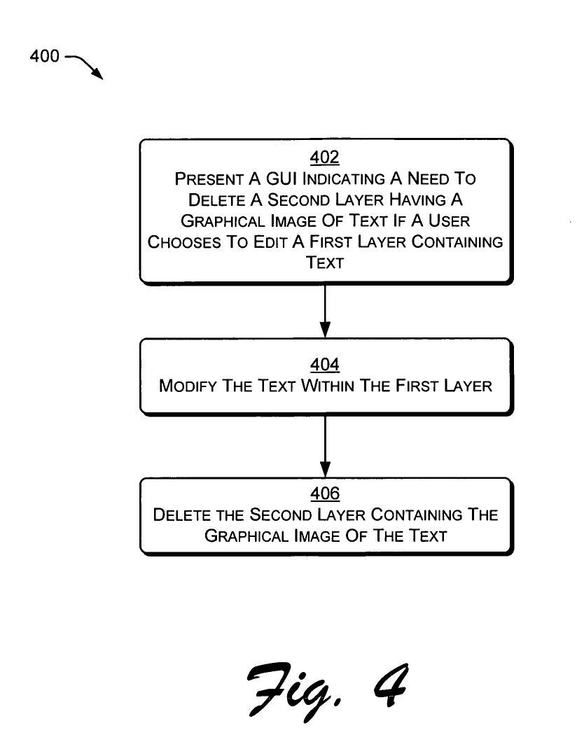

FIG. 4 is a flow diagram illustrating an example of a method 400 by which documents may be edited or otherwise altered using the system for font and text management. At block 402, a user interface (such as graphical user interface (GUI) 110) informs the author that there will be a need to delete a second layer 120 having a graphical representation 122 of text if the author chooses to edit a first layer 112 containing text 114. The graphical representation 122 of the text contained within the second layer 120 should be deleted if the text 114 contained in the first layer 112 is edited, since failure to do so would result in inconsistencies and differences between the image of the text and the text itself.

At block 404, text 114 within the first layer 112 is edited. This may be performed with any type of authoring program, such as a word processor able to interface to the layer authoring module 102. At block 406, the graphical representation 122 of the text is deleted. In one example, the graphical representation 122 is deleted automatically in response to actual editing of the text 114, which makes the representation 122 of the text obsolete.

Although the disclosure has been described in language specific to structural features and/or methodological steps, it is to be understood that the appended claims are not limited to the specific features or steps described. Rather, the specific features and steps are exemplary forms of implementing this disclosure. For example, actions described in blocks of the flow diagrams may be performed in parallel with actions described in other blocks, the actions may occur in an alternate order, or may be distributed in a manner which associates actions with more than one other block. And further, while elements of the methods disclosed are intended to be performed in any desired manner, it is anticipated that computer- and/or processor-readable instructions will be performed by a computer and/or processor, typically located within authoring and/or printing software and/or hardware, such as a computer, a printer, a print server, or similar systems. Similarly, the blocks may be performed by the actions of hardware devices, such as application specific integrated circuits (ASICs) without being embodied in software.

1. A processor-readable medium comprising processor-executable instructions for creating a document, the processor-executable instructions comprising instructions for:
configuring a first portion of the document to include text and references to fonts for use in rendering the text; and
configuring a second portion of the document to include a graphical representation of the text.

2. The processor-readable medium of claim 1, wherein configuring the first portion comprises instructions for:
embedding fonts into the first portion for use in rendering the text.

3. A processor-readable medium of claim 1, wherein the instructions are configured as a plug-in for an application.

4. The processor-readable medium of claim 1, wherein instructions for configuring the second portion of the document are executed only if input resulting from display of a user interface indicates an author preference for including the graphical representation of the text.

5. The processor-readable medium of claim 1, additionally comprising instructions for:
configuring the document according to a format selected from the group consisting of PCL, PDF and PostScript.

6. The processor-readable medium of claim 1, additionally comprising instructions for:
configuring the document according to two or more layers, wherein a first layer comprises the first portion of the document and wherein a second layer comprises the second portion of the document.

7. The processor-readable medium of claim 6, additionally comprising instructions for:
hiding one or more layers of the document to prevent detection by a document printing application not configured to recognize the one or more hidden layers.

8. The processor-readable medium of claim 1, additionally comprising instructions for:
configuring a third portion of the document to include an image.

9. The processor-readable medium of claim 8, additionally comprising instructions for:
flattening the third portion of the document with either the first portion or the second portion to convert the document for compatibility with a system that does not support processing of documents having more than one portion.

10. The processor-readable medium of claim 1, additionally comprising instructions for:
embedding fonts or references to fonts into the first layer for use in rendering the text;
displaying a user interface to obtain an author preference to control inclusion of the graphical representation of the text;
configuring the document according to a format selected from the group consisting of PCL, PDF and PostScript;
configuring the document according to two or more layers, wherein a first layer comprises the first portion of the document and wherein a second layer comprises the second portion of the document;
hiding one or more layers of the document to prevent detection by a document printing application not configured to recognize the one or more hidden layers; and
configuring a third layer of the document to include an image of the document or all images in the document.

11. The processor-readable medium of claim 1, additionally comprising instructions for:
receiving the document, wherein the first and second portions are configured;
checking to see if fonts referenced by the first portion of the document are available;
if the referenced fonts are available, then rendering text within the first portion of the document using the referenced fonts; and
if the referenced fonts are not available, then rendering the graphical representation of the text contained within the second portion of the document.

12. A method for authoring a PDF document, comprising:
configuring a first layer of the PDF document to include text and references to fonts for use in rendering the text;
displaying a user interface to allow an author to express a preference for including a graphical representation of the text; and
where the preference for including the graphical representation of the text was expressed, configuring a second layer of the PDF document to include a graphical representation of the text.

13. The method of claim 12, wherein configuring the first layer comprises:
embedding fonts into the first layer for use in rendering the text.

14. The method of claim 12, additionally comprising:
configuring the document according to a format selected from the group consisting of PCL, PDF and PostScript.

15. The method of claim 12, additionally comprising:
hiding one or more layers of the document to prevent detection by a document printing application not configured to recognize the one or more hidden layers.

16. The method of claim 12, additionally comprising:
configuring a third layer of the document to include an image.

17. The method of claim 12, additionally comprising:
embedding fonts into the first layer for use in rendering the text;
configuring the document according to a format selected from the group consisting of PCL, PDF and PostScript;
hiding one or more layers of the document to prevent detection by a document printing application not configured to recognize the one or more hidden layers; and
configuring a third layer of the document to include an image of the document or the images in the document.

18. The method of claim 12, additionally comprising:
receiving the document, wherein the first and second layers are configured;
checking to see if fonts referenced by the first layer of the document are available;
if the referenced fonts are available, then rendering text within the first layer of the document using the referenced fonts; and
if the referenced fonts are not available, then rendering the graphical representation of the text contained within the second layer of the document.

19. A method of claim 18, wherein rendering the text comprises:
obtaining the text from the first layer of the document;
obtaining the referenced fonts; and
performing the rendering using the referenced fonts with the text.

20. A processor-readable medium comprising processor-executable instructions for document rendering, the processor-executable instructions comprising instructions for:
receiving a document having first and second portions;
checking to see if fonts referenced by the first portion of the document are available;
if the referenced fonts are available, then rendering text within the first portion of the document using the referenced fonts; and
if the referenced fonts are not available, then rendering a representation of the text contained within the second portion of the document.

21. A processor-readable medium of claim 20, wherein the instructions are configured as a plug-in for an application.

22. A processor-readable medium of claim 20, wherein receiving the document comprises instructions for:
receiving a document configured as a PDF document wherein the first and second portions configured as first and second layers.

23. A processor-readable medium of claim 20, wherein receiving the document comprises instructions for:
looking for the first and second portions, wherein the first and second portions are configured as first and second layers; and
recognizing the first and second layers wherein one or both layers are hidden.

24. A processor-readable medium of claim 20, wherein the checking comprises instructions for:
looking for hidden layers within the document; and
upon locating a hidden layer, determining if fonts referenced by the hidden layer are available for use.

25. A processor-readable medium of claim 20, wherein rendering the text comprises instructions for:
obtaining the text from the first portion of the document;
obtaining the referenced fonts; and
performing the rendering of the text using the referenced fonts.

26. A processor-readable medium of claim 20, comprising further instructions for:
modifying the text within the first portion; and
discarding the representation of the text contained within the second portion.

27. A processor-readable medium of claim 26, comprising further instructions for:
presenting a user interface warning of a need to discard the representation of the text if the text is edited.

28. A document creation system, comprising:
a document authoring module to:
configure a first layer of a PDF document to include text and references to fonts for use in rendering the text;
display a user interface to allow an author to express a preference for including a graphical representation of the text; and
where the preference for including the graphical representation of the text was expressed, configuring a second layer within the PDF document to include a graphical representation of the text; and
a document printing module configured to:
receive the PDF document, wherein the first and second layers have been configured;
check to see if fonts referenced by the first layer of the document are available;
render text within the first layer of the document using the referenced fonts, if the referenced fonts are available; and
render a representation of the text contained within the second layer of the document, if the referenced fonts are not available.

29. The document creation system of claim 28, wherein the document authoring module is configured to create the document according to a format selected from the group consisting of PCL, PDF and PostScript.

30. The document creation system of claim 28, wherein the document authoring module is configured to hide one or more layers of the document to prevent detection by a document printing module not configured to recognize the one or more hidden layers.

31. The document creation system of claim 28, wherein the document authoring module is configured to create a third layer within the PDF document to contain an image of the document or the images in the document.

32. The document creation system of claim 28, wherein the first layer is configured as a hidden layer, viewable only by document printing modules configured to look for hidden layers.

33. The document creation system of claim 28, wherein the document printing module is additionally configured to:
modify the text within the first layer; and
discard the representation of the text contained within the second layer.

34. The document creation system of claim 33, wherein the document printing module is additionally configured to:
present a user interface warning of a need to discard the representation of the text if the text is edited.

35. A PDF authoring tool, comprising:
means for configuring a first layer of the PDF document to include text and references to fonts for use in rendering the text;
means for displaying a user interface to allow an author to express a preference for including a graphical representation of the text; and
means for, where the preference for including the graphical representation of the text was expressed, configuring a second layer of the PDF document to include a graphical representation of the text.

36. The PDF authoring tool of claim 35, wherein the means for configuring the first layer comprises:
means for embedding fonts into the first layer for use in rendering the text.

37. The PDF authoring tool of claim 35, additionally comprising:
means for configuring the document according to a format selected from the group consisting of PCL, PDF and PostScript.

38. The PDF authoring tool of claim 35, additionally comprising:
means for hiding one or more layers of the document to prevent detection by a document printing application not configured to recognize the one or more hidden layers.

39. The PDF authoring tool of claim 35, additionally comprising:
means for configuring a third layer of the document to include an image of the document or the images in the document.

40. The PDF authoring tool of claim 35, additionally comprising:
means for embedding fonts into the first layer for use in rendering the text;
means for configuring the document according to a format selected from the group consisting of PCL, PDF and PostScript;
means for hiding one or more layers of the document to prevent detection by a document printing application not configured to recognize the one or more hidden layers; and
means for configuring a third layer of the document to include an image of the document or images in the document.

41. The PDF authoring tool of claim 35, additionally comprising:
means for receiving the document, wherein the first and second layers are configured;
means for detecting one or more hidden layers within the document;
means for checking to see if fonts referenced by the first layer of the document are available;
means for rendering, if the referenced fonts are available, text within the first layer of the document using the referenced fonts; and
means for rendering, if the referenced fonts are not available, the graphical representation of the text contained within the second layer of the document.

42. The PDF authoring tool of claim 35, additionally comprising:
means for modifying the text within the first portion; and
means for discarding the representation of the text contained within the second portion.
